(19) United States
(12) Patent Application Publication
(10) Pub. No.: US 2006/0047075 A1
(43) Pub. Date: Mar. 2, 2006

(54) Fluoro-rubber composite, rubber material using the same, and a method of manufacturing a fluoro-rubber molded product

(75) Inventors: Tomoya Shimizu, Hamamatsu-shi (JP); Takeshi Kuboyama, Hamamatsu-shi (JP); Naoya Kuzawa, Hamamatsu-shi (JP); Hiroshi Saito, Hamamatsu-shi (JP)

Correspondence Address: OLIFF & BERRIDGE, PLC, P.O. BOX 19928, ALEXANDRIA, VA, 22320, US

(73) Assignee: NICHIAS CORPORATION, Tokyo (JP)

(21) Appl. No.: 11/212,625

(22) Filed: Aug. 29, 2005

(30) Foreign Application Priority Data
Sep. 2, 2004 (JP) 2004-255358
Mar. 30, 2005 (JP) 2005-097690

(51) Int. Cl. C08L 27/12

(52) U.S. Cl. 525/199

(57) ABSTRACT

In order to provide a fluoro-rubber composite which hardly reduces a clean degree of a manufacturing environment and in which any of cracks is hardly generated, a rubber material using the same, and a method of manufacturing a fluoro-rubber molded product, a fluoro rubber is mixed with a tetrafluoroethylene/propylene system copolymer or a tetrafluoroethylene/propylene/vinylidenefluoride system copolymer, and a fluorine thermoplastic resin, and the resulting mixture is compounded with a peroxide cross-linking agent, and a co-cross-linking agent, and if necessary, any other suitable filler or the like, thereby obtaining a fluoro-rubber composite, and cross-linking is performed for the resulting fluoro-rubber composite, thereby obtaining a fluoro-rubber molded product. A cross-linking method, for example, is such that a predetermined amount of fluoro-rubber composite is filled in a mold having a desired shape, and primary cross-linking is performed for the fluoro-rubber composite through a heat process, and if necessary, secondary cross-linking may be performed for the fluoro-rubber composite in an oven at 150 to 250° C. for 1 to 32 hours. The fluoro-rubber molded product can have an arbitrary shape such as a sheet-like shape, a rod-like shape, a ring-like shape, or any of various complicated block-like shapes in correspondence to its application.

### BACKGROUND OF THE INVENTION

1. Field of the Invention

The present invention relates to an improvement of a Fluoro-rubber composite, rubber material using the same, and a method of manufacturing a fluoro-rubber molded product.

2. Description of the Related Art

In manufacture of a semiconductor or a liquid crystal display, the processing using various kinds of plasmas such as an O₂ plasma and a CF₄ plasma is performed in the processes such as a CVD process, a dry etching process, and an ashing process for a silicon wafer or the like. A sealant having an elastomer property is used in a system using such plasmas in order to seal various kinds of connection portions and movable portions therewith.

In recent years, in order to enhance the productivity of the semiconductor manufacturing equipment, the promotion for highly densifying plasmas in a dry etching system as one of various kinds of semiconductor equipment has been developed. The density of the radicals contained in the plasmas has also increased along with the promotion for highly densifying the plasmas. As a result, there is encountered the problem that the sealant made of a rubber used in such equipment is decomposed and volatilized, which exerts a serious influence on the sealing property of the sealant. Moreover, there is also encountered the problem that cracks are generated in the sealant made of a rubber through the exposure to the radicals to cause the splits in the sealant.

As regards a method of solving those problems, for example, JP 06-302527 A discloses a technique for compounding a fluoro rubber having a relatively high resistance against the plasmas with carbon black or silica.

However, the above-mentioned prior art involves the problem that the carbon black and the silica are pulverized into particles (foreign material fine particles) and the moisture adsorbed in the carbon black and the silica is discharged to reduce the clean degree of the manufacturing environment, and thus it becomes difficult to attain the clean degree required for the recent semiconductor manufacturing equipment and semiconductor transportation system or the like for which the fineness has advanced in accordance with the semiconductor process rules. Moreover, the above-mentioned prior art also involves the problem that it is impossible to prevent the cracks from being generated in the sealant.

### SUMMARY OF THE INVENTION

The present invention has been made in the light of the above-mentioned problems associated with the prior art, and it is, therefore, an object of the present invention to provide a fluore-rubber composite which hardly reduces the clean degree of the manufacturing environment and in which any of cracks is hardly generated, a rubber material using the same, and a method of manufacturing a fluore-rubber molded product.

In order to attain the above-mentioned object, according to an aspect of the present invention, there is provided a fluore-rubber composite, in which 100 pts. wt. of a fluoro rubber is mixed with 10 to 150 pts. wt. of a tetrafluoroethylene/propylene system copolymer or a tetrafluoroethylene/propylene/vinylidene fluoride system copolymer, and 1 to 60 pts. wt. of a fluorine thermoplastic resin.

Here, preferably, a content of fluorine in the fluorine thermoplastic resin is equal to or higher than 50 wt %. In addition, preferably, 100 pts. wt. of the fluoro rubber is compounded with 0.5 to 5 pts. wt. of a peroxide cross-linking agent, and 1 to 30 pts. wt. of a co-cross-linking agent.

In addition, according to another aspect of the present invention, there is provided a rubber material formed from the fluoro-rubber molded product for semiconductor manufacturing equipment, a semiconductor transportation system, a vacuum system, or liquid crystal manufacturing equipment.

In addition, according to still another aspect of the present invention, there is provided a method of manufacturing a fluoro-rubber molded product, in which a fluorine thermoplastic resin is molten; the molten fluorine thermoplastic resin is mixed with a fluoro rubber, and a tetrafluoroethylene/propylene system copolymer or a tetrafluoroethylene/propylene/vinylidene fluoride system copolymer, and a particle size of a dispersed phase at that time is adjusted to 1 μm or less; and the resulting mixture is compounded with a cross-linking agent to perform cross-linking therefor.

According to the constitution of the present invention, it is possible to realize a fluoro-rubber composite in which a weight reduction rate and a particle generation rate are small even when the fluoro-rubber composite is exposed to the plasmas, and any of cracks is hardly generated, and which hardly reduces the clean degree of the manufacturing environment, a rubber material using the same, and a method of manufacturing a fluoro-rubber molded product.

### BRIEF DESCRIPTION OF THE DRAWINGS

FIG. 1a is an image showing results, of measurement of particle sizes of a fluorine thermoplastic resin, which are obtained through observation in Example 1 using a scanning electron microscope; and

FIG. 1b is an image showing results, of measurement of particle sizes of a fluorine thermoplastic resin, which are obtained through observation in comparative example 1 using a scanning electron microscope.

### DESCRIPTION OF THE PREFERRED EMBODIMENT(S)

Hereinafter, Embodiments of the present invention will be described.

A fluoro-rubber composite is made by mixing a fluoro rubber with a tetrafluoroethylene/propylene system copolymer or a tetrafluoroethylene/propylene/vinylidene fluoride system copolymer, and a fluorine system thermoplastic resin, and by compounding the resulting mixture with a peroxide cross-linking agent and a co-cross-linking agent, and if necessary, any other suitable filler or the like.

In addition, a fluoro-rubber molded product can be obtained by performing cross-linking for the fluoro-rubber composite. A cross-linking method is not especially limited. For example, a predetermined amount of fluoro-rubber composite is filled in a mold, and primary cross-linking is performed therefor through a heat process. Next, as may be necessary, secondary cross-linking may be performed within an oven at 150 to 250° C. for 1 to 32 hours. The fluoro-rubber molded product may have an arbitrary shape such as a sheet-like shape, a rod-like shape, a ring-like shape, or any one of various complicated block-like shapes in correspondence to its application. As a result, various rubber molded products of the present invention can be obtained.

The feature of the fluoro-rubber molded product according to the present invention obtained in such the manner as described above is that a weight reduction rate and a particle generation rate when the oxygen plasmas are applied to the fluoro-rubber molded product is equal to or smaller than 20 wt % and equal to or smaller than 1 wt %, respectively.

As regards the fluoro rubber used in the fluoro-rubber molded product according to the present invention, the conventionally known fluoro rubbers can be generally used. For example, there are given a vinylidenefluoride/hexafluoropropene system copolymer, a vinylidenefluoride/hexafluoropropene/tetrafluoroethylene system copolymer, and the like. In addition, a fluoro rubber may also be used which is obtained by further copolymerizing any one of those copolymers with ethylene, perfluoroalkylvinylether, or the like. Moreover, it is also possible to use fluorine thermoplastic elastomer or the like as a block copolymer of a fluoro rubber (vinylidenefluoride/hexafluoropropene/tetrafluoroethylene system copolymer) and a fluorocarbon polymer (tetrafluoroethylene/ethylene alternant copolymer and polyvinylidenefluoride). Of those fluoro rubbers, the vinylidenefluoride/hexafluoropropene/tetrafluoroethylene copolymer is especially suitable in terms of processability and heat resistance. In addition, it is also possible to mix a plurality of kinds of fluoro rubbers with one another. Incidentally, a fluoro rubber for which the peroxide cross-linking is possible is suitable from a viewpoint of enhancement of pureness (defined as not generating any of particles).

In addition, a composition ratio, a molecular weight, and a polymer structure of a tetrafluoroethylene/propylene system copolymer or a tetrafluoroethylene/propylene/vinylidenefluoride system copolymer to be mixed with the above-mentioned fluoro rubber are not especially limited. However, a tetrafluoroethylene/propylene copolymer which has a metal content reduced to 1.5 mass % or less and which is described in JP 2003-96220 A is preferable as the tetrafluoroethylene/propylene copolymer from a viewpoint of reduction of generation of the particles.

The tetrafluoroethylene/propylene copolymer having the metal content reduced to 1.5 mass % or less, for example, is obtained by coagulating a latex of a tetrafluoroethylene/propylene copolymer or a tetrafluoroethylene/propylene/vinylidenefluoride copolymer obtained through the emulsion polymerization, using a coagulating agent other than metallic salts. An organic solvent, an unsaturated carboxylic acid, an inorganic acid, an ammonium salt, a nonionic surface active agent, alcohol, a high molecular coagulant, and the like are given as the coagulating agents. In addition, even when a metallic salt such as sodium chloride, potassium chloride, calcium chloride, aluminium chloride, or aluminium sulfate is used, a content of metallic elements can be reduced by performing the sufficient washing. In addition, dropping a solution obtained by dissolving a solid rubber in a good solvent into a large amount of poor solvent to deposit and precipitate the solid rubber also makes it possible to reduce the content of metallic elements.

In addition, the conventionally known fluorine thermoplastic resins can be generally used as the fluorine thermoplastic resin which is mixed with the fluoro rubber and a tetrafluoroethylene/propylene copolymer or a tetrafluoroethylene/propylene/vinylidenefluoride copolymer. For example, there are given perfluoroalkoxy alkan (PFA), a perfluoroethylene/hexafluoropropene copolymer (FEP), a ethylene/tetrafluoroethylene copolymer (ETFE), a tetrafluoroethylene/hexafluoropropene/ethylen terpolymer (THE), tetrafluoroethylene/hexafluoropropene/vinylidenefluoride terpolymer (THV), polyvinylidenefluoride (PVdF), an ethylene-chlorotrifluoroethylene copolymer (ECTFF), and the like. However, the fluorine thermoplastic resin is not limited thereto. From a viewpoint of enhancement of the radical resistance, preferably, each of those fluorine thermoplastic resins has a content of fluorine (the weight rate of fluorine atoms in a resin) of 50 wt % or more. More preferably, when the content of fluorine is adjusted to 65 wt % or more, the radical resistance is further enhanced. Moreover, a resin (e.g., a THV, etc. manufactured by Dyneon) containing three kinds of monomers consisting of vinylidenefluoride, hexafluoropropene, and tetrafluoroethylene as a raw material is preferable in terms of the processability. In addition, it is also possible to use a plurality of kinds of fluorine thermoplastic resins.

In addition, organic peroxide which is generally used before the peroxide cross-linking is performed can be used as the cross-linking agent. For example, there are given dicumylperoxide, bis(t-butylperoxy)diisopropylbenzene, 2,5-dimethly-2,5-bis(t-butylperoxy)hexane, and the like. Of those organic peroxides, 2,5-dimethly-2,5-bis(t-butylperoxy)hexane is preferable in terms of enhancement of the cross-linking efficiency and the forming performance.

In addition, as regards the co-cross-linking agent, for example, there are given triallylisocyanurate (TAIC), a triallylisocyanurate prepolymer (TAIC prepolymer), triallylcyanurate, triallyl trimellitate, N,N′-m-Phenylenedimaleimide, trimethylolpropanetrimethacrylate, and the like. In addition thereto, an acrylate system monomer, a methacrylate system monomer, and the like can also be used. Of those co-cross-linking agents, the mixture of triallylisocyanurate (TAIC) and triallylisocyanurate prepolymer (TAIC prepolymer) is preferable in terms of the heat resistance, the processability, and the mechanical strength.

The fluoro-rubber composite can be manufactured using the materials described above by utilizing the various kinds of methods. At this time, a method of mixing the fluoro rubber with a tetrafluoroethylene/propylene system copolymer or a tetrafluoroethylene/propylene/vinylidenefluoride system copolymer, and the fluoric thermoplastic resin is arbitrarily selected. Thus, for example, an open roll, a kneader, a banbury mixer, a biaxial extruder, or the like can be used for the mixing method. However, the present invention is not necessarily intended to be limited thereto. In order to enhance the mechanical strength and the heat resistance, preferably, the fluoro rubber, the tetrafluoroethylene/propylene system copolymer or the tetrafluoroethylene/propylene/vinylidenefluoride system copolymer, and the fluoric thermoplastic resin are molten and mixed with one another at a temperature equal to or higher than the melting temperature of the fluorine thermoplastic resin using the kneading machine such as the kneader or the banbury mixer while the shear is applied to those materials. The particle size of the dispersed phase (fluoric thermoplastic resin) at that time is preferably adjusted to 1 μm or less. This reason is that the mechanical strength is reduced when the particle size is increased to exceed 1 μm. In addition, the moisture, the organic low molecular weight components, the hydrogen fluoride, and the like contained in the fluoro rubber, the tetrafluoroethylene/propylene system copolymer or the tetrafluoroethylene/propylene/vinylidenefluoride system copolymer, and the fluoric thermoplastic resin are volatilized through the melting and mixing process. As a result, an amount of outgas discharged from the fluoro-rubber molded product can be reduced. For example, an amount of moisture gas and hydrogen fluoride which are discharged when the fluoro-rubber molded product is heated at 1.0×10⁻⁵ Pa and at 200° C. for 1 hour can be reduced to 10 ppm or less per weight of the fluoro-rubber molded product.

If metals are contained in the fluoro rubber, the tetrafluoroethylene/propylene system copolymer or the tetrafluoroethylene/propylene/vinylidenefluoride system copolymer, the fluoric thermoplastic resin, the peroxide cross-linking agent, the co-cross-linking agent, and the like, this will cause the particles to generate when those materials are exposed to the plasmas or the radicals. For this reason, using the tetrafluoroethylene/propylene system copolymer or tetrafluoroethylene/propylene/vinylidenefluoride system copolymer in which a content of metals contained therein is equal to or less than 1.5 mass % when being calculated based on the metallic elements, and the fluoro rubber, the fluoric thermoplastic resin, the peroxide cross-linking agent, the co-cross-linking agent, and the like in which a content of metals contained therein is equal to or less than 1,000 ppm, preferably equal to or less than 100 ppm when being calculated based on the metallic elements makes it possible to obtain the fluoro-rubber molded product in which the particle generation rate, i.e., the rate of the weight of the particles generated per unit weight of the fluoro-rubber molded product is equal to or smaller than 1 wt %.

In addition, mixing 100 pts. wt. of the fluoro rubber with 10 to 150 pts. wt., preferably 20 to 100 pts. wt. of the tetrafluoroethylene/propylene system copolymer or the tetrafluoroethylene/propylene/vinylidenefluoride system copolymer, and 1 to 60 pts. wt., preferably 5 to 40 pts. wt. of the fluoric thermoplastic resin makes it possible to obtain the fluoro-rubber molded product which is excellent in radical resistance, crack resistance, heat resistance, processability, and handling property.

Moreover, compounding 100 pts. wt. of the fluoro rubber with 0.5 to 5 pts. wt., preferably 1 to 3 pts. wt. of the peroxide cross-linking agent, and 1 to 30 pts. wt., preferably 2 to 20 pts. wt. of the co-cross-linking agent makes it possible to obtain the fluoro-rubber molded product which is excellent in heat resistance and mechanical property. When the compounding amount of peroxide cross-linking agent and the compounding amount of co-cross-linking agent become smaller than the above-mentioned values, respectively, the cross-linking becomes insufficient. As a result, the mechanical strength and the compression set do not take the satisfactory values, respectively. On the other hand, when the compounding amount of peroxide cross-linking agent and the compounding amount of co-cross-linking agent become larger than the above-mentioned values, respectively, the nonconformity occurs in which the fluoro-rubber molded product becomes too hard and thus shows small elongation, or the forming failure occurs.

The fluoro-rubber molded product according to the present invention shows the high radical resistance since the material which is obtained by mixing the fluoro rubber with the tetrafluoroethylene/propylene system copolymer or the tetrafluoroethylene/propylene/vinylidenefluoride system copolymer, and the fluoric thermoplastic resin as the raw material. For example, the weight reduction rate of the fluoro-rubber molded product when the fluoro-rubber molded product is exposed to the oxygen plasma for 2 hours in a surface wave plasma generating system having an output power of 3000 W is equal to smaller than 20 wt %. In addition, as described above, since the content of metals contained in the raw material is reduced, the particle generation rate can be adjusted to 1 wt % or less.

In addition, the fluoro-rubber molded product according to the present invention is excellent in heat resistance, chemical resistance, low discharge gas property, and pureness as well as in radical resistance, and crack resistance. For this reason, the fluoro-rubber molded product according to the present invention is suitable as the rubber material which is used in the severe environment such as the high temperature environment or the vacuum environment in the semiconductor manufacturing equipment, the semiconductor transportation system, the liquid crystal manufacturing equipment, the vacuum system, or the like. In particular, the fluoro-rubber molded product according to the present invention can be used as the sealant which is exposed to such radicals as those in the plasma etching system, the plasma ashing system, or the plasma CVD system.

In addition, as regards the kinds of plasma gases used in the above-mentioned plasma processing system, there are generally given O₂, CF₄, O₂+CF₄, H₂, CHF₃, CH₃F, CH₂F₂, Cl₂, C₂F₆, BCl₂, NF₃, NH₃, and the like. However, the fluoro-rubber molded product according to the present invention shows the excellent durability against the radicals in the plasmas irrespective of such kinds of plasmas.

### EXAMPLES

### Examples of the present invention will hereinafter be described. It should be noted that the present invention is not intended to be limited to the following examples.

(Forming Method)

The fluoro rubber, the tetrafluoroethylene/propylene system copolymer, and the fluorine thermoplastic resin shown in TABLE 1 were molten and mixed with one another at rates shown in TABLE 1. The resulting mixture, the cross-linking agent, and the co-cross-linking agent were kneaded in the open roll to obtain the fluoro-rubber composite. The resulting fluoro-rubber composite was filled in the mold, and then the cross-linking forming was performed for the fluoro-rubber composite at a mold temperature of 170° C. for 3 minutes. Thereafter, the secondary bridge was performed for the fluoro-rubber composite in the oven at 180° C. for 16 hours to obtain a rubber sheet and JISP-26 O rings.

At that, as the tetrafluoroethylene/propylene copolymer, AFLAS® manufactured by ASAHI GLASS CO., LTD. was coagulated and refined, so that a content of metals contained therein was reduced to 1 mass % or less (0.6 mass %). The resulting copolymer was used as the above-mentioned tetrafluoroethylene/propylene copolymer.

(Evaluation on General Physical Properties)

The general physical properties were evaluated under the following condition.
Tensile strength and elongation during cutting: based on JISK6251
Hardness: based on JISK6253
   (Evaluation on Radical Resistance)

A test piece was exposed to the radicals under the following conditions, and the radical resistance was evaluated based on the weight reduction rate of the test piece before and after the exposure to the radicals. In addition, the test piece was cleaned and dried after completion of the weight measurement after the exposure to the radicals, and then the weight of the test piece was measured again to measure the particle generation rate.
System: surface wave plasma etching system manufactured by SHINKO SEIKI CO., LTD.
Specimen: sheet 20 mm square with 2 mm thickness
Gas: O₂ (2,000 ml/min)
Processing pressure: 133 Pa
Output power: 3 kW
Exposure time: 2 hours
Weight reduction rate (wt %)=(weight before exposure to radicals−weight right after exposure to radicals)/(weight before exposure to radicals)×100
Particle generation rate (wt %)=(weight right after exposure to radicals−weight after exposure to radicals and cleaning)/(weight before exposure to radicals)×100
   (Evaluation on Crack Resistance Against Radicals)

The P26 O rings were exposed to the plasmas under the same conditions as those of the foregoing for 30 minutes with the P26 O rings being elongated by 8%. The crack generation states on the surfaces of the P26 O rings were evaluated through the visual observation. The P26 O ring having no crack was marked with “o”, the P26 O ring having the cracks generated therein was marked with “Δ”, and the cut P26 O ring was marked with “x”.

(Outgas Analysis)

Amounts of outgases (moisture gas, hydrogen fluoride gas, organic low molecular weight gas, etc.) generated from the O rings under the following conditions were analyzed.
System: temperature programmed desorption gas analyzer of TPD type V manufactured by RIGAKU CORPORATION
Specimens: pieces with 10 mm size obtained by cutting O rings
Temperature condition: 200° C. for 1 hour
Temperature rising speed: 10 K/min

Degree of vacuum: 1×10⁻⁵ Pa

| | | Example 1 | Example 2 | Example 3 | Example 4 | Example 5 |
|---|---|---|---|---|---|---|
| fluoro rubber \textcircled{1} | DAIEL ®G912 manufactured by DAIKIN | 100 | 100 | 100 | 100 | — |
| | INDUSTRIES, LTD. | | | | | |
| fluoro rubber \textcircled{2} | Viton ®ETP VTR-8710 manufactured by | — | — | — | — | 100 |
| | DuPont | | | | | |
| fluoro rubber \textcircled{3} | LTFE6400X manufactured by Dyneon | — | — | — | — | — |
| tetrafluoroethylene/propylene copolymer | AFLAS ®150C manufactured by ASAHI | 40 | 40 | 100 | 20 | 40 |
| | GLASS CO., LTD. | | | | | |
| thermoplastic resin \textcircled{1} | Dyneon ™THV X610G manufactured by | 15 | 45 | 15 | 15 | — |
| | Sumitomo 3M Limited | | | | | |
| thermoplastic resin \textcircled{2} | FEP-5100J manufactured by DuPont | — | — | — | — | 30 |
| particle size of dispersed phase(μm) | | 1 | 1 | 1 | 1 | 1 |
| MT carbon | | — | — | — | — | — |
| cross-linking agent | PERHEXA ®25B manufactured by NOF | 1.5 | 1.5 | 1.5 | 1.5 | 1.5 |
| | CORPORATION | | | | | |
| co-cross-linking agent | TAIC ®prepolymer manufactured by | 7 | 4 | 7 | 7 | 3 |
| | Nippon Kasei Chemical | | | | | |
| | TAIC prepolymer manufactured by | 7 | 7 | 7 | 7 | 3 |
| | Nippon Kasei Chemical | | | | | |
| tensile strength (MPa) | | 21.5 | 21.1 | 16.2 | 20.4 | 18.7 |
| elongation during cutting (%) | | 237 | 269 | 360 | 244 | 221 |
| 100% stress (MPa) | | 6.4 | 5.8 | 5.0 | 4.6 | 4.5 |
| hardness (duro A) | | 75 | 76 | 73 | 70 | 76 |
| weight reduction rate due to radicals (%) | | 5.7 | 6.0 | 7.3 | 5.6 | 7.3 |
| particle generation rate due to radicals (%) | | 0.02 | 0.00 | 0.01 | 0.02 | 0.04 |
| crack resistance | | ◯ | ◯ | ◯ | Δ | ◯ |
| moisture outgas (ppm) | | 2.43 | — | — | — | — |

| | | Comparative | Comparative | Comparative | Comparative |
|---|---|---|---|---|---|
| | | Example 1 | Example 2 | Example 3 | Example 4 |
| fluoro rubber \textcircled{1} | DAIEL ®G912 manufactured by DAIKIN | 100 | — | 100 | 100 |
| | INDUSTRIES, LTD. | | | | |
| fluoro rubber \textcircled{2} | Viton ®ETP VTR-8710 manufactured by | — | — | — | — |
| | DuPont | | | | |
| fluoro rubber \textcircled{3} | LTFE6400X manufactured by Dyneon | — | 100 | — | — |
| tetrafluoroethylene/propylene copolymer | AFLAS ®150C manufactured by ASAHI | — | — | 5 | — |
| | GLASS CO., LTD. | | | | |
| thermoplastic resin \textcircled{1} | Dyneon ™THV X610G manufactured by | 20 | — | 15 | — |
| | Sumitomo 3M Limited | | | | |
| thermoplastic resin \textcircled{2} | FEP-5100J manufactured by DuPont | — | — | — | — |
| particle size of dispersed phase(μm) | | 10 | — | 1 | — |
| MT carbon | | — | — | — | 20 |
| cross-linking agent | PERHEXA ®25B manufactured by NOF | 2 | 2 | 1.5 | 2 |
| | CORPORATION | | | | |
| co-cross-linking agent | TAIC ®prepolymer manufactured by | 6 | 2 | 7 | 6 |
| | Nippon Kasei Chemical | | | | |
| | TAIC prepolymer manufactured by | — | — | 7 | — |
| | Nippon Kasei Chemical | | | | |
| tensile strength (MPa) | | 7.2 | 3.7 | 13.5 | 22.0 |
| elongation during cutting (%) | | 213 | 337 | 235 | 154 |
| 100% stress (MPa) | | 2.4 | 0.9 | 2.0 | 11.2 |
| hardness (duro A) | | 75 | 52 | 73 | 78 |
| weight reduction rate due to radicals (%) | | 12.2 | 28.8 | 7.1 | 16.2 |
| particle generation rate due to radicals (%) | | 0.04 | 0.00 | 0.01 | 1.57 |
| crack resistance | | X | X | X | X |
| moisture outgas (ppm) | | — | — | — | 21.0 |

TABLE 1 shows the various kinds of evaluation results. It should be noted that in TABLE 1, Examples 1 to 5 show the raw materials of the fluoro-rubber molded products according to the present invention and the evaluation results, and Comparative examples 1 to 4 show the raw materials of the fluoro-rubber molded products according to the Comparative examples and the evaluation results.

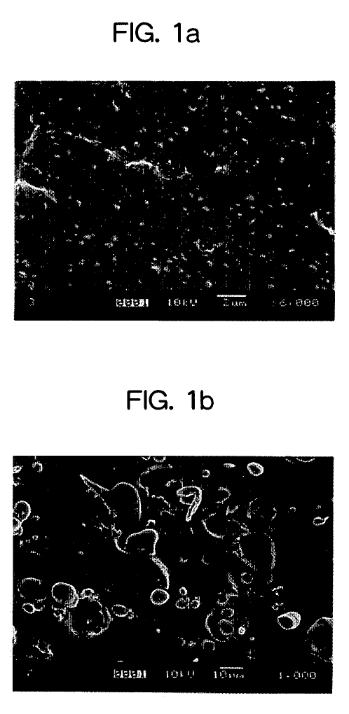

In addition, FIG. 1a shows the results, of measurement of particle sizes of the fluorine thermoplastic resin, obtained through observation using a scanning electron microscope according to Example 1. FIG. 1b shows the results, of measurement of particle sizes of the fluorine thermoplastic resin, obtained through observation using a scanning electron microscope according to Comparative example 1.

As shown in Examples 1 to 5 of TABLE 1, any of the fluoro-rubber molded products according to the present invention shows the satisfactory mechanical strength such as the tensile strength, the small weight reduction rate due to the radicals, and the excellent crack resistance as compared with any of the fluoro-rubber molded products according to Comparative examples 1 to 4. Moreover, any of the fluoro-rubber molded products according to the present invention shows the smaller particle generation rate than that in Comparative example 4.

On the other hand, in case of Comparative example 1, the size of the particle, as the dispersed phase, of the fluorine thermoplastic resin is 10 μm. As shown in FIG. 1b, that particle size is undoubtedly larger than that in Example 1 shown in FIG. 1a. As a result, in case of Comparative example 1, the mechanical strength is lowered. In addition, since no fluorine thermoplastic resin is used in Comparative example 2, the weight reduction due to the radicals is large, and thus the mechanical strength is weak. In addition, since a less mixing amount of tetrafluoroethylene/prolylene copolymer is used in Comparison example 3, the crack resistance is poor. Moreover, though in case of Comparison example 4, the mechanical strength is increased due to compounding of the carbon black, the particle generation rate and the amount of outgas are increased due to the compounding of the carbon black.

What is claimed is:

1. A fluoro-rubber composite, wherein 100 pts. wt. of a fluoro rubber is mixed with 10 to 150 pts. wt. of a tetrafluoroethylene/propylene system copolymer or a tetrafluoroethylene/propylene/vinylidenefluoride system copolymer, and 1 to 60 pts. wt. of a fluorine thermoplastic resin.

2. A fluoro-rubber composite according to claim 1, wherein a content of fluorine in said fluorine thermoplastic resin is equal to or larger than 50 wt %.

3. A fluoro-rubber composite according to claim 1, wherein 100 pts. wt. of said fluoro rubber is compounded with 0.5 to 5 pts. wt. of a peroxide cross-linking agent, and 1 to 30 pts. wt. of a co-cross-linking agent.

4. A fluoro-rubber composite according to claim 2, wherein 100 pts. wt. of said fluoro rubber is compounded with 0.5 to 5 pts. wt. of a peroxide cross-linking agent, and 1 to 30 pts. wt. of a co-cross-linking agent.

5. A fluoro-rubber composite according to claim 3, wherein a content of metals contained in said tetrafluoroethylene/propylene system copolymer or tetrafluoroethylene/propylene/vinylidenefluoride system copolymer is equal to or less than 1.5 mass % when being calculated based on metallic elements, and a content of metals contained in said fluoro rubber, said fluorine thermoplastic resin, said peroxide cross-linking agent, and said co-cross-linking agent is equal to or less than 1,000 ppm when being calculated based on the metallic elements.

6. A fluoro-rubber molded product obtained by performing cross-linking for said fluoro-rubber composite according to claim 1, wherein a weight reduction rate and a particle generation rate of said fluoro-rubber molded product when said fluoro-rubber molded product is exposed to plasmas for 2 hours in a surface wave plasma generating system having an output power of 3,000 W are equal to or smaller than 20 wt % and equal to or smaller than 1 wt %, respectively.

7. A fluoro-rubber molded product according to claim 6, wherein an amount of moisture gas and hydrogen fluoride gas which are discharged when said fluoro-rubber molded product is heated at 1.0×10⁻⁵ Pa and at 200° C. for 1 hour is equal to or less than 10 ppm per weight of said fluoro-rubber molded product.

8. A rubber material for a semiconductor manufacturing equipment or a semiconductor transportation system, wherein said rubber material is formed from said fluoro-rubber molded product according to claim 6.

9. A rubber material for a vacuum system, wherein said rubber material is formed from said fluoro-rubber molded product according to claim 6.

10. A rubber material for a liquid crystal manufacturing equipment, wherein said rubber material is formed from said fluoro-rubber molded product according to claim 6.

11. A method of manufacturing a fluoro-rubber molded product, wherein a fluorine thermoplastic resin is molten; said molten fluorine thermoplastic resin is mixed with a tetrafluoroethylene/propylene system copolymer or a tetrafluoroethylene/propylene/vinylidenefluoride system copolymer, and a particle size of a dispersed phase at that time is adjusted to 1 μm or less; and said resulting mixture is compounded with a cross-linking agent to perform cross-linking for said mixture.
